(19) United States
(12) Patent Application Publication
(10) Pub. No.: US 2023/0326175 A1
(43) Pub. Date: Oct. 12, 2023

(54) Method for a Luminance and Chrominance Correction

(71) Applicant: XI'AN NOVASTAR TECH CO., LTD., Xi'an, Shaanxi (CN)

(72) Inventors: Yue ZHANG, Xi'an, Shaanxi (CN); Hongchun CONG, Xi'an, Shaanxi (CN); Cheng YANG, Xi'an, Shaanxi (CN)

(21) Appl. No.: 18/022,275

(22) PCT Filed: Aug. 28, 2020
(86) PCT No.: PCT/CN2020/112260

§ 371 Date: Feb. 21, 2023

(51) Int. Cl. G06V 10/60; H04N 1/60; G06V 10/56

(52) U.S. Cl. CPC G06V 10/60; H04N 1/60; G06V 10/56

(57) ABSTRACT

A method for a luminance and chrominance correction. The method may include: image input data is acquired; a first correction on the image input data is performed, to obtain a first correction result; and a second correction is performed on to the first correction result, to obtain a second correction result, wherein the first correction is one of multiple layers of luminance correction and at least one layer of chrominance correction, and the second correction is the other of the multiple layers of the luminance correction and the at least one layer of the chrominance correction. The method solves a technical problem that the display uniformity of different grayscales still cannot be effectively improved when luminance and chrominance differences are solved in the related art.

### TECHNICAL FIELD

The present application relates to a technical field of image processing, and in particular, to a method for a luminance and chrominance correction.

### BACKGROUND

Due to process limitations such as lamp point manufacturing, sorting and packaging, at least one Light-Emitting Diode (LED) display screen generally has point-by-point luminance and chrominance differences when leaving factories, thus bringing a non-uniform display effect. Therefore, point-by-point non-uniformity correction of the LED display screen becomes an indispensable link for improving a display quality of the LED display screen. At present, an luminance control of most LED display screens is mainly realized by Pulse Width Modulation (PWM). And a common correction method is to collect lamp point luminance data of the LED display screen under a certain grayscale, so as to generate a corresponding correction coefficient, that is, a PWM compensation ratio. Then, the correction coefficient is applied to all display grayscales.

In the related art, ordinary luminance and chrominance correction depends on LED luminance linearity. And if the LED luminance linearity is poor, visual uniformity of different grayscales after correction is poor. Since LED driving technology changes from Passive Matrix (PM) to Active Matrix (AM), an LED nonlinear problem becomes more and more obvious. the non-uniformity of an image (Mura, different degrees of color difference for the same light source and the same ground color picture is visually sensed through a red-green light) of different grayscales differs a lot, so that the related art cannot adapt to such application scenarios.

In view of the above problem that an display uniformity of different grayscales still cannot be effectively improved, when luminance and chrominance differences are solved in the related art, no effective solution has been proposed yet at present.

### SUMMARY

Embodiments of the present application provide a method for a luminance and chrominance correction, so as to at least solve a technical problem that the display uniformity of different grayscales still cannot be effectively improved, when the luminance and chrominance differences are solved in the related art.

According to one aspect of the embodiments of the present application, a method for a luminance and chrominance correction is provided, including: image input data is acquired; a first correction is performed on the image input data, to obtain a first correction result; and a second correction is performed on the first correction result, to obtain a second correction result, wherein the first correction is one correction of multiple layers of luminance correction and at least one layer of chrominance correction, and the second correction is the other correction of the multiple layers of the luminance correction and the at least one layer of the chrominance correction.

Optionally, the step that the first correction is performed on the image input data, to obtain the first correction result may include: the chrominance correction is performed on the image input data according to a chrominance correction coefficient, to obtain chrominance-corrected image input data; and the chrominance-corrected image input data is determined as the first correction result.

Optionally, the step that the second correction is performed according to the first correction result, to obtain the second correction result may include: a hierarchical position where the chrominance-corrected image input data is located is determined; a luminance correction coefficient corresponding to the chrominance-corrected image input data is acquired according to the hierarchical position; the luminance correction is performed on the chrominance-corrected image input data according to the luminance correction coefficient, to obtain luminance and chrominance-corrected image input data; and the luminance and chrominance-corrected image input data is determined as the second correction result. In an implementation method, the chrominance correction is performed at first, and then the multiple layers of the luminance correction is performed, so as to improve the uniformity correction of an LED display screen at all grayscales.

Optionally, the step that the first correction is performed on the image input data, to obtain the first correction result may include: a hierarchical position where the image input data is located is determined; a luminance correction coefficient corresponding to the image input data is acquired according to the hierarchical position; the luminance correction is performed on the image input data according to the luminance correction coefficient, to obtain luminance-corrected image input data; and the luminance-corrected image input data is determined as the first correction result.

Optionally, the step that the second correction is performed according to the first correction result, to obtain the second correction result may include: the chrominance correction is performed on the luminance-corrected image input data, according to a chrominance correction coefficient, to obtain luminance and chrominance-corrected image input data; and the luminance and chrominance-corrected image input data is determined as the second correction result. In an implementation method, the multiple layers of the luminance correction is performed at first, and then the chrominance correction is performed, so as to improve the uniformity correction of the LED display screen at all grayscales.

Optionally, the method may further include: the image input data is collected by an image collection device, to obtain at least two levels of luminance measurement values; fitting is performed according to the at least two levels of the luminance measurement values, to obtain a luminance fitting curve; a correction target curve is set according to the luminance fitting curve and a correction target result; a mapping correction value of a grayscale is acquired according to the correction target curve; and the luminance correction coefficient is obtained according to the mapping correction value of the grayscale. By means of performing segmented luminance fitting according to the luminance measurement values of different levels, a fitting curve is obtained, such that the correction target curve is effectively obtained, thereby acquiring an optimal luminance correction coefficient, and luminance and chrominance effect is improved.

Optionally, the method further may include: the image input data is collected by the image collection device, so as to obtain a luminance and chrominance measurement value of each lamp point of a selected chrominance layer; the luminance and chrominance measurement value is converted to obtain a converted luminance and chrominance measurement value; a luminance value is adjusted in the converted luminance and chrominance measurement value of the each lamp point, according to a common correction target luminance value of a specified layer in the luminance correction; inverse conversion is performed according to the adjusted luminance value and chrominance information in the converted luminance and chrominance measurement value, to obtain a tristimulus value; and the chrominance correction coefficient is acquired according to the tristimulus value and a target value.

According to one aspect of the embodiments of the present application, an apparatus for a luminance and chrominance correction is provided, including: an acquisition module, configured to acquire image input data; a first correction module, configured to perform a first correction on the image input data, to obtain a first correction result; and a second correction module, configured to perform a second correction on the first correction result, to obtain a second correction result, wherein the first correction is one correction of multiple layers of luminance correction and at least one layer of chrominance correction, and the second correction is the other correction of the multiple layers of luminance correction and at least one layer of the chrominance correction.

Optionally, the first correction module may include: a first correction unit, configured to perform the chrominance correction on the image input data according to a chrominance correction coefficient, to obtain chrominance-corrected image input data; and a first determination unit, configured to determine the chrominance-corrected image input data as the first correction result.

Optionally, the second correction module may include: a first position determination unit, configured to determine a hierarchical position where the chrominance-corrected image input data is located; a first coefficient acquisition unit, configured to acquire a luminance correction coefficient corresponding to the chrominance-corrected image input data according to the hierarchical position; a second correction unit, configured to perform the luminance correction on the chrominance-corrected image input data according to the luminance correction coefficient, to obtain luminance and chrominance-corrected image input data; and a second determination unit, configured to determine the luminance and chrominance-corrected image input data as the second correction result.

Optionally, the first correction module may include: a second position determination unit, configured to determine a hierarchical position where the image input data is located; a second coefficient acquisition unit, configured to acquire a luminance correction coefficient corresponding to the image input data according to the hierarchical position; a third correction unit, configured to correct the image input data according to the luminance correction coefficient, to obtain luminance-corrected image input data; and a third determination unit, configured to determine the luminance-corrected image input data as the first correction result.

Optionally, the second correction module may include: a fourth correction unit, configured to perform the chrominance correction on the luminance-corrected image input data according to a chrominance correction coefficient, to obtain luminance and chrominance-corrected image input data; and a fourth determination unit, configured to determine the luminance and chrominance-corrected image input data as the second correction result.

Optionally, the apparatus further may include: a first collection module, configured to collect the image input data by an image collection device, to obtain at least two levels of luminance measurement values; a fitting module, configured to perform fitting according to the at least two levels of the luminance measurement values, to obtain a luminance fitting curve; a setting module, configured to set a correction target curve according to the luminance fitting curve and a correction target result; a digit acquisition module, configured to acquire a mapping correction value of a grayscale according to the correction target curve; and a luminance correction coefficient acquisition module, configured to obtain the luminance correction coefficient according to the mapping correction value of the grayscale. By means of performing segmented luminance fitting according to the luminance measurement values of different levels, a fitting curve is obtained, such that the correction target curve is effectively obtained, thereby an optimal luminance correction coefficient is acquired, and the luminance and chrominance correction effect is improved.

Optionally, the apparatus may further include: a second collection module, configured to collect the image input data by an image collection device, to obtain a luminance and chrominance measurement value of each lamp point of a selected chrominance layer; a first conversion module, configured to convert the luminance and chrominance measurement value, to obtain a converted luminance and chrominance measurement value; an adjustment module, configured to adjust a luminance value in the converted luminance and chrominance measurement value of the each lamp point, according to a common correction target luminance value of a specified layer in the luminance correction; a second conversion module, configured to perform inverse conversion according to the adjusted luminance value and chrominance information in the converted luminance and chrominance measurement value, to obtain a tristimulus value; and a chrominance correction coefficient acquisition module, configured to acquire the chrominance correction coefficient, according to the tristimulus value and a target value.

According to one aspect of the embodiments of the present application, a non-transitory storage medium is provided, wherein the non-transitory storage medium may include a stored computer program, and when the computer program is running, a device where the non-transitory storage medium is located is controlled to perform the above method.

According to one aspect of the embodiments of the present application, a processor is provided, wherein the processor is configured to run a computer program, and the computer program is run by a processor to executes the above method while running.

In the embodiments of the present application, image input data is acquired; a first correction is performed on the image input data, to obtain the first correction result; and a second correction is performed on the first correction result, to obtain the second correction result, wherein the first correction is one correction of multiple layers of luminance correction and at least one layer of chrominance correction, and the second correction is the other correction of the multiple layers of the luminance correction and the at least one layer of the chrominance correction. The purpose of effectively improving the quality of LED correction is achieved, thereby a technical effect of improving the uniformity correction of the LED display screen at all grayscales is realized, and then solving a technical problem that the display uniformity of different grayscales still cannot be effectively improved when luminance and chrominance differences are solved in the related art.

### BRIEF DESCRIPTION OF THE DRAWINGS

The drawings described herein are used for providing a further understanding of the present application, and constitute a part of the present application, and illustrative embodiments of the present application and descriptions thereof are used for explaining the present application, and do not constitute improper limitations to the present application. In the drawings:

FIG. 1 is a schematic flow diagram of a method for a luminance and chrominance correction according to an embodiment of the present application;

FIG. 2 is a schematic diagram of a first manner in the method for a luminance and chrominance correction according to an embodiment of the present application;

FIG. 3 is a schematic diagram of a second manner in the method for a luminance and chrominance correction according to an embodiment of the present application;

FIG. 4 is a schematic diagram of luminance correction implementation in the method for a luminance and chrominance correction according to an embodiment of the present application;

FIG. 5 is a schematic diagram of a fitting curve and a correction target curve in the method for a luminance and chrominance correction according to an embodiment of the present application; and

FIG. 6 is a schematic diagram of an apparatus for a luminance and chrominance correction according to an embodiment of the present application.

### DETAILED DESCRIPTION OF THE EMBODIMENTS

In order that those skilled in the art may better understand the solutions of the present application, a clear and complete description of technical solutions in the embodiments of the present application will be given below, in combination with the drawings in the embodiments of the present application. Apparently, the embodiments described below are merely a part, but not all, of the embodiments of the present application. All of other embodiments, obtained by those ordinary skilled in the art based on the embodiments of the present application without any creative effort, fall into the protection scope of the present application.

It should be noted that, the terms “first” and “second” and the like in the specification, claims and the above-mentioned drawings of the present application are used for distinguishing similar objects, and are not necessarily used for describing a specific sequence or precedence order. It should be understood that the data used in this way may be interchanged under appropriate circumstances, so that the embodiments of the present application described herein may be implemented in a sequence other than those illustrated or described herein. Furthermore, the terms “including” and “having”, and any variations thereof are intended to cover non-exclusive inclusions, for example, processes, methods, systems, products or devices including a series of steps or units are not necessarily limited to those clearly listed steps or units, but may include other steps or units that are not clearly listed or are inherent to these processes, methods, products or devices.

According to the embodiments of the present application, a method embodiment for a luminance and chrominance correction is provided. It should be noted that, the steps shown in the flow diagram of drawings may be executed in a computer system such as a group of computer-executable instructions, and although a logical sequence is shown in the flow diagram, in some cases, the illustrated or described steps may be executed in a different sequence than here.

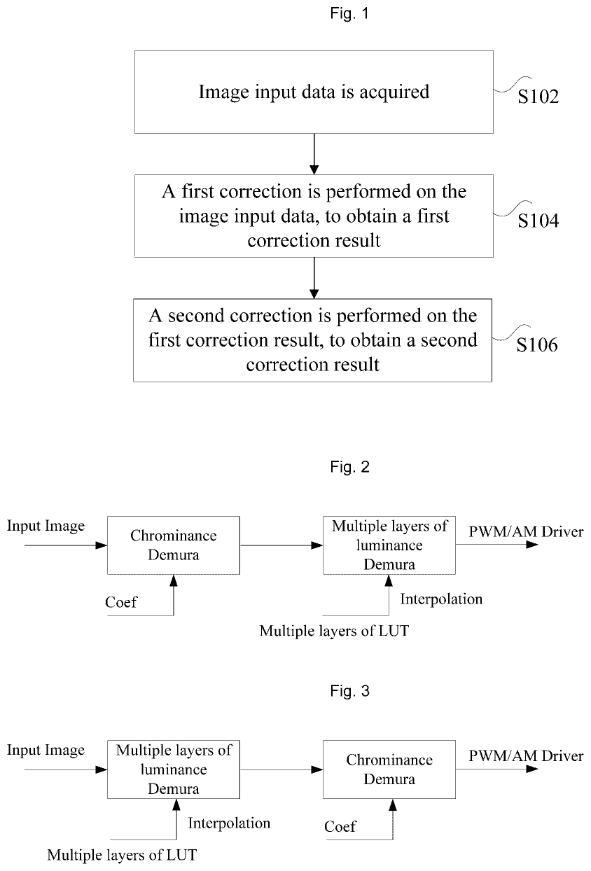

FIG. 1 is a schematic flow diagram of a method for a luminance and chrominance correction according to an embodiment of the present application, and as shown in FIG. 1, the method may include the following steps.

At step S102, image input data is acquired.

At step S104, a first correction is performed on the image input data, to obtain a first correction result.

At step S106, a second correction is performed on the first correction result, to obtain a second correction result,
wherein the first correction is one correction of multiple layers of luminance correction and at least one layer of chrominance correction, and the second correction is the other correction of the multiple layers of the luminance correction and the at least one layer of the chrominance correction.

Optionally, in the embodiment of the present application, the multiple layers of luminance correction may be at least two layers of the luminance correction. And in implementation, correction is performed on a luminance correction coefficient in multiple grayscale layers, the grayscale layer described herein refers to a grayscale. For example, when displayable grayscales of one display screen are 0-255, it indicates that the display screen may display data of 256 grayscales, that is to say, 256 grayscale layers.

Similarly, in the embodiment of the present application, at least one layer of the chrominance correction is illustrated by taking single-layer chrominance correction as an example. Since the chrominance Mura of an LED display screen in different grayscale layers is basically consistent, the luminance Mura difference relative to different layers can be ignored, and visual characteristics of human eyes are more sensitive to luminance difference. Therefore, the use of a method for a single-layer chrominance correction can conform to visual perception characteristics of human eyes, and data storage amount can be reduced without loss of precision. It should be noted that, the embodiment of the present application can also use the multiple layers of the chrominance correction, which is not limited to a single layer chrominance correction herein.

In summary, in combination with steps S102 to S106, the method for a luminance and chrominance correction provided in the embodiment of the present application can be combined with a multi-layer correction method. That is to say, a method for combining the multiple layers of the luminance correction with at least one layer of the chrominance correction. The method for a luminance and chrominance correction provided in the embodiment of the present application is applicable to LED display screens in a PM driving mode and an AM driving mode, and does not depend on LED luminance linearity, such that display uniformity of different grayscales after correction can be improved at the same time.

PM driving: passive site selection driving (Passive Matrix), also referred to as passive addressing, unactive addressing, passive driving, and so on; and

AM driving: active site selection driving, (Active Matrix), also referred to as active addressing, initiative addressing, and active driving, and so on.

In the method for a luminance and chrominance correction provided in the embodiment of the present application, the LED luminance and chrominance uniformity is corrected in a multi-layer correction method, so that the uniformity of all the grayscales can be improved to a great extent. In order to reduce the data storage amount and to ensure a correction precision, in the method for a luminance and chrominance correction provided in the embodiment of the present application, correction data is divided into two parts, that is to say, a luminance correction and a chrominance correction, and a solution of storing multiple layers of luminance correction data and single-layer chrominance correction data is utilized. During display, the most appropriate luminance correction coefficient and the most appropriate chrominance correction coefficient are selected in real time, according to an input condition of the image input data, so as to improve the luminance and chrominance correction effect.

Optionally, in the method for a luminance and chrominance correction provided in the embodiment of the present application, the method of combining the luminance correction coefficient with the chrominance correction coefficient may include the following two methods:
The first manner: the single-layer chrominance correction data with multiple layers of luminance correction data are combined.

In an optional implementation, the step S104 that the first correction is performed on the image input data, to obtain the first correction result may include: the chrominance correction is performed on the image input data, to obtain chrominance-corrected image input data; and the chrominance-corrected image input data is determined as the first correction result.

In an optional implementation, the step S106 that the second correction is performed according to the first correction result, to obtain the second correction result may include: at least two layers of the luminance correction is performed on the chrominance-corrected image input data, to obtain luminance and chrominance-corrected image input data; and the luminance and chrominance-corrected image input data is determined as the second correction result.

The method of correcting the image input data is to perform single-layer chrominance correction at first, and after the chrominance-corrected image input data is obtained, perform at least two layers of the luminance correction (i.e., multiple layers of the luminance correction) on the chrominance-corrected image input data, to obtain the luminance and chrominance-corrected image input data, thereby the uniformity correction of the LED display screen is improved at all grayscales.

Optionally, the step that the chrominance correction is performed on the image input data, to obtain the chrominance-corrected image input data may include: the chrominance correction is performed on the image input data according to a chrominance correction coefficient, to obtain the chrominance-corrected image input data.

The step of that the at least two layers of the luminance correction is performed on the chrominance-corrected image input data, to obtain the luminance and chrominance-corrected image input data may include: a hierarchical position where the chrominance-corrected image input data is located is determined; a luminance correction coefficient corresponding to the chrominance-corrected image input data is acquired according to the hierarchical position; and the luminance correction is performed on the chrominance-corrected image input data according to the luminance correction coefficient, to obtain the luminance and chrominance-corrected image input data.

As shown in FIG. 2, FIG. 2 is a schematic diagram of a first manner in the method for a luminance and chrominance correction according to an embodiment of the present application. During correction, an Input signal (i.e., the image input data in the embodiment of the present application) is directly multiplied by the chrominance correction coefficient (Coef) in a chrominance Demura module, then a result of multiplication obtained enters a multiple layers of luminance Demura. The result of multiplication obtained is located between which two Layers (i.e., the hierarchical position where the chrominance-corrected image input data is located in the embodiment of the present application is determined) is judged in real time, and interpolation (i.e., the luminance correction coefficient corresponding to the chrominance-corrected image input data is acquired according to the hierarchical position, and the luminance correction is performed on the chrominance-corrected image input data according to the luminance correction coefficient in the embodiment of the present application) is performed according to the luminance correction LUT (i.e., multiple layers of LUT, the luminance correction coefficient in the embodiment of the present application) of the two Layers, so as to achieve the purpose of selecting the most appropriate luminance correction coefficient and to improve the correction effect, and then a result of the interpolation is processed by a PWM/AM Driver.

The second manner: the multiple layers of the luminance correction data is combined with the single-layer chrominance correction data

In an optional implementation, the step S104 that the first correction is performed on the image input data, to obtain the first correction result may include: at least two layers of luminance correction is performed on the image input data, to obtain luminance-corrected image input data; and the luminance-corrected image input data is determined as the first correction result.

In an optional implementation, the step S106 that the second correction is performed according to the first correction result, to obtain the second correction result may include: the chrominance correction is performed on the luminance-corrected image input data, to obtain luminance and chrominance-corrected image input data; and the luminance and chrominance-corrected image input data is determined as the second correction result.

The manner of correcting the image input data is to perform at least two layers of luminance correction (i.e., multiple layers of the luminance correction) at first, and after the chrominance-corrected image input data is obtained, single-layer chrominance correction is performed on the chrominance-corrected image input data, to obtain the luminance and chrominance-corrected image input data, thereby the uniformity correction of the LED display screen is improved at all grayscales.

Optionally, the step that the at least two layers of the luminance correction is performed on the image input data, to obtain the luminance-corrected image input data may include: a hierarchical position where the image input data is located is determined; a luminance correction coefficient corresponding to the image input data is acquired according to the hierarchical position; and the luminance correction is performed on the image input data according to the luminance correction coefficient, to obtain the luminance-corrected image input data.

The step that the chrominance correction is performed on the luminance-corrected image input data, to obtain the luminance and chrominance-corrected image input data may include: the chrominance correction is performed on the luminance-corrected image input data, according to a chrominance correction coefficient, to obtain the luminance and chrominance-corrected image input data.

As shown in FIG. 3, FIG. 3 is a schematic diagram of a second manner in the method for a luminance and chrominance correction according to an embodiment of the present application. During luminance and chrominance correction, the Input signal being located between which two Layers (i.e., the hierarchical position where the image input data is located is determined in the embodiment of the present application) is judged in real time according to the Input signal (i.e., the image input data in the embodiment of the present application), and interpolation (i.e., the luminance correction coefficient corresponding to the corrected image input data is acquired according to the hierarchical position in the embodiment of the present application) is performed according to the luminance correction LUT (i.e., the luminance correction coefficient in the embodiment of the present application) of the two Layers, so as to achieve the purpose of selecting the most appropriate luminance correction coefficient; and then a result of the interpolation enters the chrominance Demura module to be directly multiplied by the chrominance correction coefficient (Coef). That is to say, a single-layer chrominance correction parameter is used (i,e., the luminance correction is performed on the image input data according to the luminance correction coefficient, to obtain luminance-corrected image input data, and the chrominance correction is performed on the luminance-corrected image input data according to the chrominance correction coefficient, to obtain the luminance and chrominance-corrected image input data in the embodiment of the present application), and then a result of multiplication is processed by a PWM/AM Driver.

It should be noted that, during real-time processing, an appropriate luminance correction coefficient can be selected according to the grayscale value of the image input data, while the chrominance correction coefficient may be related to a collection position of chrominance information.

Based on the above, a process of acquiring the luminance correction coefficient and the chrominance correction coefficient in the method for a luminance and chrominance correction provided in the embodiment of the present application is specifically as follows:

1. A Process of Acquiring the Luminance Correction Coefficient.

In an optional implementation, the luminance and the method for a chrominance correction provided in the embodiment of the present application may further include: the image input data is collected by an image collection device, to obtain at least two levels of luminance measurement values; fitting is performed according to the at least two levels of the luminance measurement values, to obtain a luminance fitting curve; a correction target curve is set according to the luminance fitting curve and a correction target result; a mapping correction value of a grayscale is acquired according to the correction target curve; and the luminance correction coefficient is obtained according to the mapping correction value of the grayscale. By means of performing segmented luminance fitting according to the luminance measurement values of different levels, a fitting curve is obtained, such that the correction target curve is effectively obtained, thereby an optimal luminance correction coefficient is acquired, and the luminance and chrominance correction effect is improved.

In the embodiment of the present application, the image collection device may be an area-array camera with an XYZ color filter wheel. During a collection process of the image input data, the image input data obtained by using the area-array camera with the XYZ color filter wheel to photograph the LED display screen may be used. It should be noted that in the embodiment of the present application, the image collection device is not limited to the area-array camera with the XYZ color filter wheel.

in a preferred implementation, in order to improve an efficiency and reduce storage resources in the method for a luminance and chrominance correction provided in the embodiment of the present application, several Layers of red, green and blue (RGB) three primary colors are collected to cover low grayscale, medium grayscale and high grayscale. For example, five grayscales of Gray=[32, 64, 128, 192, 255] under a certain standard display Gamma are collected, so that collected features are more obvious due to the collection from the low grayscale to the high grayscale.

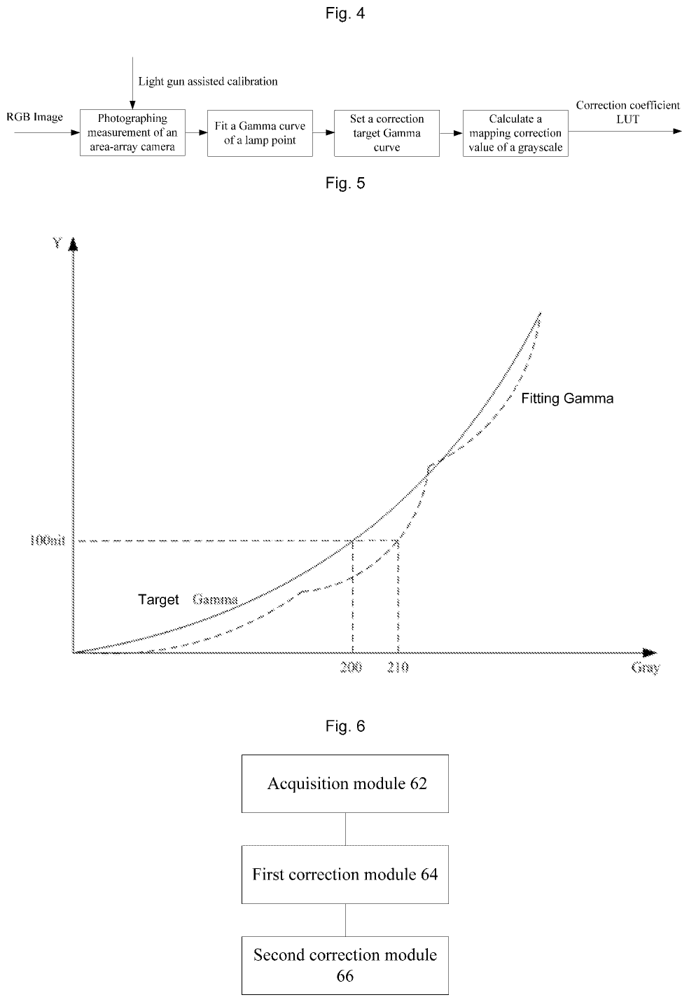

Optionally, FIG. 4 is a schematic diagram of luminance correction implementation in the method for a luminance and chrominance correction according to an embodiment of the present application. As shown in FIG. 4, the method for a luminance and chrominance correction provided in the embodiment of the present application is to photograph the LED display screen by using the area-array camera with the XYZ color filter wheel. All Layers need to collect a filter image for a luminance Y. A certain Layer is selected as a chrominance layer, and X filter image and Z filter image are additionally collected for standby. Meanwhile, the measurement value of a certain area on the screen and the measurement value of the area by the area-array camera are assisted calibrated by using a light gun, so that a point-by-point luminance measurement value Y or a luminance and chrominance measurement values XYZ on the LED display screen can be obtained.

For a certain lamp point, the luminance Y data of the five Layers (i.e., the at least two levels of luminance measurement values in the embodiment of the present application) are used, and a piecewise Gamma curve of the lamp point is fitted by using methods such as linear interpolation, polynomial fitting and exponential function fitting (i.e., fitting is performed according to the at least two levels of luminance measurement values, to obtain the luminance fitting curve in the embodiment of the present application). As shown in FIG. 5, FIG. 5 is a schematic diagram of a fitting curve and a correction target curve in the method for a luminance and chrominance correction according to an embodiment of the present application, wherein a dotted line represents a fitting Gamma curve of the lamp point.

A correction target Gamma curve is set according to requirements of the correction target result, as shown in a black curve in FIG. 5.

A mapping correction value of the grayscale is calculated according to the correction target Gamma curve, to obtain correction coefficient LUT. For example, if a luminance of 200 grayscales needs to be displayed, then 210 gray scales are sent to the lamp point. In order to save storage resources and reduce a transmission bandwidth, a correction coefficient corresponding to the 200 grayscales of the lamp point may be denoted as +10.

By analogy, a common target Gamma curve is used for obtaining the luminance correction coefficients of several Layers point by point on the LED display screen, so that the luminance of the LED display screen subjected to luminance correction is uniform.

2. A Process of Acquiring the Chrominance Correction Coefficient.

In an optional implementation, the method for a luminance and chrominance correction provided in the embodiment of the present application may further include: the image input data is collected by the image collection device, to obtain a luminance and chrominance measurement value of each lamp point of a selected chrominance layer; the luminance and chrominance measurement value is converted to obtain a converted luminance and chrominance measurement value; a luminance value in the converted luminance and chrominance measurement value of each the lamp point is adjusted, according to a common correction target luminance value of a specified layer in the luminance correction; inverse conversion is performed according to the adjusted luminance value and chrominance information in the converted luminance and chrominance measurement value, to obtain a tristimulus value; and the chrominance correction coefficient is acquired, according to the tristimulus value and a target value.

In the method for a luminance and chrominance correction provided in the embodiment of the present application, one-time luminance uniformity adjustment is performed on the image input, data. Meanwhile, in order to reduce the data storage amount, ensure, the correction precision and conform to the perception characteristics of the human eyes, the method for a luminance and chrominance correction provided in the embodiment of the present application is illustrated by taking one-layer chrorninance correction as an example, which is not specifically limited as long as the method for a luminance and chrorninance correction provided in the embodiment of the present application can be implemented.

Since the chrominance Mura of the LED display screen in different grayscale layers is basically consistent, the luminance Mura difference relative to different layers can be ignored, and the visual characteristics of human eyes are more sensitive to the luminance difference. Therefore, the use of a single-layer chrominance correction method in the method for a luminance and chrominance correction provided in the embodiment of the present application may conform to visual perception characteristics of human eyes, and the data storage amount can be reduced without the loss of precision.

A process of acquiring the chrominance correction coefficient may be as follows.

At step 1: for each lamp point of the selected chrominance layer in a luminance correction portion, using the collected luminance and chrominance measurement value XYZ data of the lamp point to complete the conversion from. XYZ to Lxy, according to the following formula, wherein XYZ represents a tristimulus value, L represents luminance, and XY represents color coordinates.

$$L = Y$$

$$\text{?} = \frac{X}{X + Y + Z}$$

$$y = \frac{Y}{X + Y + Z}$$

$$\text{?} \text{indicates text missing or illegible when filed}$$

At step 2: the luminance uniformity is adjusted. The measurement luminance values L of all lamp points are adjusted by using a common correction target luminance value of a layer in the luminance correction, and the chrominance information xy is retained, or, the target luminance value is multiplied by a global ratio for adjustment.

At step 3: the data processed in step 2 is inversely converted into XYZ data according to the formula in step 1, and the chrominance correction coefficient is calculated according to the following formula.

Coef×Measured=Target
wherein Coef represents the correction coefficient, Measured presents the collected tristimulus value, and Target represents the selected target value.

Optionally, an image of a single-layer LED display screen is collected by using an area-array industrial camera with an XYZ color filter wheel, a point-by-point RGB three-primary-color tristimulus value XYZ is extracted, a common target value is selected, and then the chrominance correction coefficient is obtained according to the formula in step 3.

Based on the above, the method for a luminance and chrominance correction provided in the embodiment of the present application does not depend on the LED luminance linearity, so that the correction uniformity is synchronously improved regardless of the low grayscale, the medium grayscale or the high grayscale. In the embodiments of the present application, image input data is acquired; a first correction is performed on the image input data, to obtain the first correction result; and a second correction is performed on the first correction result, to obtain the second correction result, wherein the first correction is one correction of multiple layers of luminance correction and at least one layer of chrominance correction, and the second correction is the other correction of the multiple layers of the luminance correction and the at least one layer of the chrominance correction. The purpose of effectively improving the quality of LED correction is achieved, thereby realizing the technical effect of improving the uniformity correction of the LED display screen at all grayscales, and then solving the technical problem that the display uniformity of different grayscales still cannot be effectively improved when luminance and chrominance differences are solved in the related art.

According to the embodiments of the present application, an embodiment of an apparatus for a luminance and chrominance correction is provided. FIG. 6 is a schematic diagram of an apparatus for a luminance and chrominance correction according to an embodiment of the present application,. As shown in FIG. 6, the apparatus for a luminance and chrominance correction provided in the embodiment of the present application may include: an acquisition module 62, configured to acquire image input data; a first correction module 64, configured to perform a first correction on the image input data, to obtain a first correction result; and a second correction module 66, configured to perform a second correction on the first correction result, to obtain a second correction result, wherein the first correction is one correction of multiple layers of luminance correction and at least one layer of chrominance correction, and the second correction is the other correction of the multiple layers of the luminance correction and the at least one layer of the chrominance correction.

Optionally, the first correction module 64 may include: a first correction unit, configured to perform the chrominance correction on the image input data according to a chrominance correction coefficient, to obtain chrominance-corrected image input data; and a first determination unit, configured to determine the chrominance-corrected image input data as the first correction result.

Further, optionally, the second correction module 66 may include: a first position determination unit, configured to determine a hierarchical position where the chrominance-corrected image input data is located; a first coefficient acquisition unit, configured to acquire a luminance correction coefficient corresponding to the chrominance-corrected image input data according to the hierarchical position; a second correction unit, configured to perform the luminance correction on the chrominance-corrected image input data, according to the luminance correction coefficient, to obtain luminance and chrominance-corrected image input data; and a second determination unit, configured to determine the luminance and chrominance-corrected image input data as the second correction result.

Optionally, the first correction module 64 may include: a second position determination unit, configured to determine a hierarchical position where the image input data is located; a second coefficient acquisition unit, configured to acquire a luminance correction coefficient corresponding to the image input data according to the hierarchical position; a third correction unit, configured to correct the image input data according to the luminance correction coefficient, to obtain luminance-corrected image input data; and a third determination unit, configured to determine the luminance-corrected image input data as the first correction result.

Further, optionally, the second correction module 66 may include: a fourth correction unit, configured to perform the chrominance correction on the luminance-corrected image input data according to a chrominance correction coefficient, to obtain luminance and chrominance-corrected image input data; and a fourth determination unit, configured to determine the luminance and chrominance-corrected image input data as the second correction result.

Optionally, the luminance and chrominance correction apparatus provided in the embodiment of the present application may further include: a first collection module, configured to collect the image input data by an image collection device, to obtain at least two levels of luminance measurement values; a fitting module, configured to perform fitting according to the at least two levels of the luminance measurement values, to obtain a luminance fitting curve; a setting module, configured to set a correction target curve according to the luminance fitting curve and a correction target result; a digit acquisition module, configured to acquire a mapping correction value of a grayscale according to the correction target curve; and a luminance correction coefficient acquisition module, configured to obtain the luminance correction coefficient according to the mapping correction value of the grayscale. By means of performing segmented luminance fitting according to the luminance measurement values of different levels, a fitting curve is obtained, such that the correction target curve is effectively obtained, thereby an optimal luminance correction coefficient is acquired, and the luminance and chrominance correction effect is improved.

Optionally, the apparatus for the luminance and chrominance correction is provided in the embodiment of the present application may further include: a second collection module, configured to collect the image input data by an image collection device, to obtain a luminance and chrominance measurement value of each lamp point of a selected chrominance layer; a first conversion module, configured to convert the luminance and chrominance measurement value, to obtain a converted luminance and chrominance measurement value; an adjustment module, configured to adjust a luminance value in the converted luminance and chrominance measurement value of each the lamp point, according to a common correction target luminance value of a specified layer in the luminance correction; a second conversion module, configured to perform inverse conversion according to the adjusted luminance value and chrominance information in the converted luminance and chrominance measurement value, to obtain a tristimulus value; and a chrominance correction coefficient acquisition module, configured to acquire the chrominance correction coefficient, according to the tristimulus value and a target value.

As described above, a specific working principles of the apparatus for a luminance and chrominance correction are the same as the method in the above Embodiment, reference may be specifically made to the related descriptions of the above Embodiment, and thus details are not described herein again.

According to another aspect of the embodiments of the present application, a non-transitory storage medium is further provided, wherein the non-transitory storage medium may include a stored computer program, and when the computer program is running, a device where the non-transitory storage medium is located is controlled to perform the method in the above Embodiment.

According to one aspect of the embodiments of the present application, a processor is provided, wherein the processor is configured to run a computer program, and the computer program performs the method in the above Embodiment while running.

The serial numbers of the above embodiments of the present application are only for description, and do not represent the advantages or disadvantages of the embodiments.

In the above embodiments of the present application, the description of each embodiment has its own emphasis. For parts that are not described in detail in a certain embodiment, reference may be made to related descriptions of other embodiments.

In the several embodiments provided by the present application, it should be understood that, the disclosed technical content may be implemented in other manners. The apparatus embodiments described above are merely exemplary, for example, a division of the units is only a logic function division, there may be other division manners in practical implementations, for example, multiple units or components may be combined or integrated to another system, or some features may be omitted or not executed. From another point of view, the displayed or discussed mutual coupling or direct coupling or communication connection may be indirect coupling or communication connection of units or modules through some interfaces, and may be in electrical or other forms.

The units described as separate components may be separated physically or not, components displayed as units may be physical units or not, namely, may be located in one place, or may be distributed on multiple units. A part of or all of the units may be selected to implement the purposes of the solutions in the present embodiment according to actual demands.

In addition, the functional units in various embodiments of the present application may be integrated in a processing unit, or the units individually exist physically, or two or more units are integrated in one unit. The integrated unit may be implemented in a form of hardware, and may also be implemented in a form of a software functional unit.

If the integrated unit is implemented in the form of the software functional unit and is sold or used as an independent product, it may be stored in a computer-readable storage medium. Based on this understanding, the technical solutions of the present application substantially, or the part contributing to the related art, or part of or all the technical solutions may be implemented in the form of a software product, the computer software product is stored in a storage medium, and may include several instructions for enabling a computer device (which may be a personnel computer, a server, or a network device or the like) to execute all or part of the steps of the method in various embodiments of the present application. The foregoing storage medium may include a variety of media capable of storing program codes, such as a USB disk, a read-only memory (ROM, Read-Only Memory), a random access memory (RAM, Random Access Memory), a mobile hard disk, a magnetic disk, or an optical disk.

The foregoing descriptions are merely specific embodiments of the present application. It should be pointed out that, those ordinary skilled in the art may make several improvements and modifications without departing from the principles of the present application, and these improvements and modifications should also be regarded as a protection scope of the present application.

What is claimed is:

1. A method for a luminance and chrominance correction, comprising:
acquiring image input data;
performing a first correction on the image input data, to obtain a first correction result; and
performing a second correction on the first correction result, to obtain a second correction result,
wherein the first correction is one correction of a plurality of layers of luminance correction and at least one layer of chrominance correction, and the second correction is the other correction of the plurality of layers of the luminance correction and the at least one layer of the chrominance correction.

2. The method as claimed in claim 1, wherein performing the first correction on the image input data, to obtain the first correction result comprises:
performing the chrominance correction on the image input data according to a chrominance correction coefficient, to obtain chrominance-corrected image input data; and
determining the chrominance-corrected image input data as the first correction result.

3. The method as claimed in claim 2, wherein performing the second correction on the first correction result, so as to obtain the second correction result comprises:
determining a hierarchical position where the chrominance-corrected image input data is located;
acquiring a luminance correction coefficient corresponding to the chrominance-corrected image input data according to the hierarchical position;
performing the luminance correction on the chrominance-corrected image input data according to the luminance correction coefficient, to obtain luminance and chrominance-corrected image input data; and
determining the luminance and chrominance-corrected image input data as the second correction result.

4. The method as claimed in claim 1, wherein performing the first correction on the image input data, to obtain the first correction result comprises:
determining a hierarchical position where the image input data is located;
acquiring a luminance correction coefficient corresponding to the image input data according to the hierarchical position;
performing the luminance correction on the image input data according to the luminance correction coefficient, to obtain luminance-corrected image input data; and
determining the luminance-corrected image input data as the first correction result.

5. The method as claimed in claim 4, wherein performing the second correction on first correction result, to obtain the second correction result comprises:
performing the chrominance correction on the luminance-corrected image input data, according to a chrominance correction coefficient, to obtain luminance and chrominance-corrected image input data; and
determining the luminance and chrominance-corrected image input data as the second correction result.

6. The method as claimed in claim 3, wherein the method further comprises:
collecting the image input data by an image collection device, to obtain at least two levels of luminance measurement values;
performing fitting according to the at least two levels of the luminance measurement values, to obtain a luminance fitting curve;
setting a correction target curve according to the luminance fitting curve and a correction target result;
acquiring a mapping correction value of a grayscale according to the correction target curve; and
obtaining the luminance correction coefficient according to the mapping correction value of the grayscale.

7. The method as claimed in claim 2, wherein the method further comprises:
collecting the image input data by an image collection device, to obtain a luminance and chrominance measurement value of each lamp point of a selected chrominance layer;
converting the luminance and chrominance measurement value, to obtain a converted luminance and chrominance measurement value;
adjusting a luminance value in the converted luminance and chrominance measurement value of each the lamp point, according to a common correction target luminance value of a specified layer in the luminance correction;
performing inverse conversion according to the adjusted luminance value and chrominance information in the converted luminance and chrominance measurement value, to obtain a tristimulus value; and
acquiring the chrominance correction coefficient, according to the tristimulus value and a target value.

8. (canceled)

9. (canceled)

10. (canceled)

11. (canceled)

12. (canceled)

13. (canceled)

14. (canceled)

15. A non-transitory storage medium, wherein the non-transitory storage medium comprises a stored computer program, and when the computer program is running, a device where the non-transitory storage medium is located is controlled to perform the following steps:
acquiring image input data;
performing a first correction on the image input data, to obtain a first correction result; and
performing a second correction on the first correction result, to obtain a second correction result,
wherein the first correction is one correction of a plurality of layers of luminance correction and at least one layer of chrominance correction, and the second correction is the other correction of the plurality of layers of the luminance correction and the at least one layer of the chrominance correction.

16. A processor, wherein the processor is configured to run a computer program, and the computer program is run by a processor to perform the following steps:
acquiring image input data;
performing a first correction on the image input data, to obtain a first correction result; and
performing a second correction on the first correction result, to obtain a second correction result,
wherein the first correction is one correction of a plurality of layers of luminance correction and at least one layer of chrominance correction, and the second correction is the other correction of the plurality of layers of the luminance correction and the at least one layer of the chrominance correction.

17. The non-transitory storage medium as claimed in claim 15, wherein performing the first correction on the image input data, to obtain the first correction result comprises:
performing the chrominance correction on the image input data according to a chrominance correction coefficient, to obtain chrominance-corrected image input data; and
determining the chrominance-corrected image input data as the first correction result.

18. The non-transitory storage medium as claimed in claim 17, wherein performing the second correction Currently Amended the first correction result, so as to obtain the second correction result comprises:
determining a hierarchical position where the chrominance-corrected image input data is located;
acquiring a luminance correction coefficient corresponding to the chrominance-corrected image input data according to the hierarchical position;
performing the luminance correction on the chrominance-corrected image input data according to the luminance correction coefficient, to obtain luminance and chrominance-corrected image input data; and
determining the luminance and chrominance-corrected image input data as the second correction result.

19. The non-transitory storage medium as claimed in claim 15, wherein performing the first correction on the image input data, to obtain the first correction result comprises:
determining a hierarchical position where the image input data is located;
acquiring a luminance correction coefficient corresponding to the image input data according to the hierarchical position;
performing the luminance correction on the image input data according to the luminance correction coefficient, to obtain luminance-corrected image input data; and
determining the luminance-corrected image input data as the first correction result.

20. The non-transitory storage medium as claimed in claim 19, wherein performing the second correction on the first correction result, to obtain the second correction result comprises:
performing the chrominance correction on the luminance-corrected image input data, according to a chrominance correction coefficient, to obtain luminance and chrominance-corrected image input data; and
determining the luminance and chrominance-corrected image input data as the second correction result.

21. The non-transitory storage medium as claimed in claim 18, wherein the non-transitory storage medium is further controlled to perform the following steps:
collecting the image input data by an image collection device, to obtain at least two levels of luminance measurement values;
performing fitting according to the at least two levels of the luminance measurement values, to obtain a luminance fitting curve;
setting a correction target curve according to the luminance fitting curve and a correction target result;
acquiring a mapping correction value of a grayscale according to the correction target curve; and obtaining the luminance correction coefficient according to the mapping correction value of the grayscale.

22. The processor as claimed in claim 16, wherein performing the first correction on the image input data, to obtain the first correction result comprises:
performing the chrominance correction on the image input data according to a chrominance correction coefficient, to obtain chrominance-corrected image input data; and
determining the chrominance-corrected image input data as the first correction result.

23. The processor as claimed in claim 22, wherein performing the second correction Currently Amended the first correction result, so as to obtain the second correction result comprises:
determining a hierarchical position where the chrominance-corrected image input data is located;
acquiring a luminance correction coefficient corresponding to the chrominance-corrected image input data according to the hierarchical position;
performing the luminance correction on the chrominance-corrected image input data according to the luminance correction coefficient, to obtain luminance and chrominance-corrected image input data; and
determining the luminance and chrominance-corrected image input data as the second correction result.

24. The processor as claimed in claim 16, wherein performing the first correction on the image input data, to obtain the first correction result comprises:
determining a hierarchical position where the image input data is located;
acquiring a luminance correction coefficient corresponding to the image input data according to the hierarchical position;
performing the luminance correction on the image input data according to the luminance correction coefficient, to obtain luminance-corrected image input data; and
determining the luminance-corrected image input data as the first correction result.

25. The processor as claimed in claim 24 wherein performing the second correction on the first correction result, to obtain the second correction result comprises:
performing the chrominance correction on the luminance-corrected image input data, according to a chrominance correction coefficient, to obtain luminance and chrominance-corrected image input data; and
determining the luminance and chrominance-corrected image input data as the second correction result.

26. The method as claimed in claim 4, wherein the method further comprises:
collecting the image input data by an image collection device, to obtain at least two levels of luminance measurement values;
performing fitting according to the at least two levels of the luminance measurement values, to obtain a luminance fitting curve;
setting a correction target curve according to the luminance fitting curve and a correction target result;
acquiring a mapping correction value of a grayscale according to the correction target curve; and
obtaining the luminance correction coefficient according to the mapping correction value of the grayscale.

27. The method as claimed in claim 5, wherein the method further comprises:
collecting the image input data by an image collection device, to obtain a luminance and chrominance measurement value of each lamp point of a selected chrominance layer;
converting the luminance and chrominance measurement value, to obtain a converted luminance and chrominance measurement value;
adjusting a luminance value in the converted luminance and chrominance measurement value of each the lamp point, according to a common correction target luminance value of a specified layer in the luminance correction;
performing inverse conversion according to the adjusted luminance value and chrominance information in the converted luminance and chrominance measurement value, to obtain a tristimulus value; and
acquiring the chrominance correction coefficient, according to the tristimulus value and a target value.
